(19) United States
(12) Patent Application Publication
(10) Pub. No.: US 2011/0198920 A1
(43) Pub. Date: Aug. 18, 2011

(54) Vehicle power supply apparatus

(75) Inventors: Masaki Komuro, Tokyo (JP); Yutaka Sato, Tokyo (JP); Mikio Ono, Tokyo (JP)

(73) Assignee: Fuji Jukogyo Kabushiki Kaisha, Tokyo (JP)

(21) Appl. No.: 12/929,630

(22) Filed: Feb. 4, 2011

(30) Foreign Application Priority Data
Feb. 12, 2010 (JP) 2010-028888

(51) Int. Cl. B60L 1/00

(52) U.S. Cl. 307/10.1; 903/930

(57) ABSTRACT

A first power supply system is constituted by an alternator and a main battery while a second power supply system is constituted by electrical equipment and a sub-battery. Further, a switch is provided between the first power supply system and the second power supply system. During vehicle deceleration, the switch is switched to a disconnected state, whereby the first power supply system and the second power supply system are disconnected. As a result, a generation voltage of the alternator can be raised, enabling an increase in the generation amount, without applying an excessive voltage to the electrical equipment. Hence, the main battery can be charged sufficiently during deceleration, and therefore the alternator can be halted during acceleration and steady travel. Furthermore, by halting the alternator, an engine load can be reduced, and as a result, an improvement in the fuel efficiency of the vehicle can be achieved.

### CROSS-REFERENCE TO RELATED APPLICATIONS

The present application claims priority from Japanese Patent Application No. 2010-028888, filed on Feb. 12, 2010, and is hereby incorporated by reference in its entirety.

### BACKGROUND OF THE INVENTION

1. Field of the Invention

The present invention relates to a vehicle power supply apparatus installed in a vehicle.

2. Description of the Related Art

In a conventional vehicle, power is typically supplied to electrical equipment by the use of a lead storage battery. Although it is possible to secure a large storage capacity with a lead storage battery, the battery deteriorates rapidly through charging and discharging. Hence, in a vehicle installed with a lead storage battery, charging and discharging of the lead storage battery is prevented by driving an alternator (a power generator) to generate power at all times. However, when the alternator is driven constantly, an engine load increases, leading to a reduction in fuel efficiency. In response to this problem, a vehicle having a lithium ion battery in addition to a lead storage battery, wherein a generation voltage of an alternator is controlled to zero during acceleration and raised during deceleration, has been proposed (see Japanese Unexamined Patent Application Publication No. 2004-225649, for example). By controlling the alternator while avoiding an increase in the engine load in this manner, the fuel efficiency of the vehicle can be improved. Note that when power generation driving of the alternator is halted, power is supplied to the electrical equipment from the lithium ion battery, thereby preventing discharging of the lead storage battery.

However, in the vehicle described in Japanese Unexamined Patent Application Publication No. 2004-225649, the electrical equipment is connected to a power system of the alternator, making it impossible to raise the generation voltage of the alternator greatly. In other words, the generation voltage cannot be set above an upper limit voltage of the electrical equipment, and it is therefore difficult to secure a sufficient amount of regeneration in the alternator during deceleration. When a sufficient amount of regeneration cannot be secured during deceleration, the alternator must be driven to generate power at times other than deceleration periods, and as a result, the engine load increases, leading to a reduction in the fuel efficiency of the vehicle.

### SUMMARY OF THE INVENTION

An object of the present invention is to improve the fuel efficiency of a vehicle by increasing a regeneration amount of a power generator.

A vehicle power supply apparatus according to the present invention includes: a first power supply system including a power generator and a first storage body connected to the power generator; a second power supply system including an electric load having a lower upper limit voltage than the power generator and a second storage body connected to the electric load; and a switch that is provided between the first power supply system and the second power supply system, and is switched between a connected state in which the first power supply system and the second power supply system are connected and a disconnected state in which the first power supply system and the second power supply system are disconnected.

In the vehicle power supply apparatus according to the present invention, when the switch is switched to the disconnected state, a generation voltage of the power generator is set to be higher than the upper limit voltage of the electric load, and when the switch is switched to the connected state, the generation voltage of the power generator is set at or below the upper limit voltage of the electric load.

In the vehicle power supply apparatus according to the present invention, the switch is switched to the disconnected state during vehicle deceleration.

According to the present invention, by switching the switch provided between the first power supply system and the second power supply system to the disconnected state, the generation voltage of the power generator can be raised, enabling an increase in the regeneration amount of the power generator. Accordingly, the power generator can be halted actively, and as a result, the fuel efficiency of the vehicle can be improved.

### BRIEF DESCRIPTION OF THE DRAWINGS

FIG. 1 is a schematic view showing the constitution of a vehicle including a vehicle power supply apparatus according to an embodiment of the present invention;

FIG. 2 is an illustrative view showing control states of a switch;

FIG. 3 is an illustrative view showing power supply states of the vehicle power supply apparatus;

FIGS. 4A and 4B are illustrative views showing power supply states of the vehicle power supply apparatus;

FIG. 5 is an illustrative view showing a relationship between switch control executed on the switch and regeneration control of an alternator;

FIGS. 6A and 6B are illustrative views showing power supply states of the vehicle power supply apparatus during engine startup;

FIG. 7 is a schematic view showing the constitution of a vehicle including a vehicle power supply apparatus according to a further embodiment of the present invention; and

FIG. 8 is a schematic view showing the constitution of a vehicle including a vehicle power supply apparatus according to a further embodiment of the present invention.

### DESCRIPTION OF THE PREFERRED EMBODIMENTS

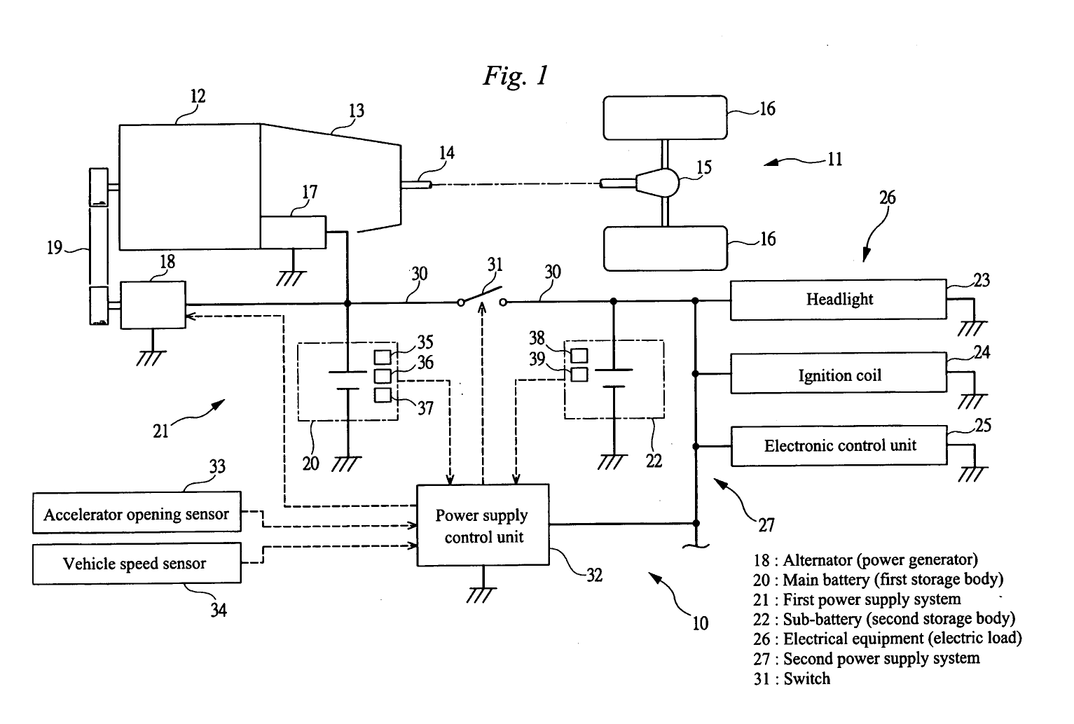

Embodiments of the present invention will be described in detail below on the basis of the drawings. FIG. 1 is a schematic view showing the constitution of a vehicle 11 including a vehicle power supply apparatus 10 according to an embodiment of the present invention. As shown in FIG. 1, the vehicle 11 is installed with an engine 12 and a transmission 13. Drive wheels 16 are coupled to an output shaft 14 of the transmission 13 via a differential mechanism 15. Further, a starter motor 17 is attached to the engine 12. Furthermore, an alternator 18 serving as a power generator is coupled to the engine 12 via a drive belt 19. Note that the vehicle 11 shown in the drawing is a so-called micro-hybrid vehicle installed with a low voltage regeneration system employing the alternator 18. When depression of an accelerator pedal is released such that the vehicle decelerates, the alternator 18 is driven to generate power, whereby kinetic energy of the vehicle 11 is actively converted into electric energy and collected. Further, when the accelerator pedal is depressed such that the vehicle accelerates or travels steadily, power generation by the alternator 18 is halted, leading to a reduction in an engine load. By controlling the alternator 18 to ensure that the engine load does not increase in this manner, a fuel efficiency of the vehicle 11 is improved.

Incidentally, to improve the fuel efficiency of the vehicle 11, it is important to halt driving the alternator 18 for power generation during acceleration and steady travel, as noted above. However, in a conventional vehicle that includes only a lead storage battery as a storage body, it is difficult to stop driving the alternator 18 for power generation in order to prevent deterioration of the lead storage battery caused by charging and discharging. To solve this problem, a lithium ion battery or the like that is highly resistant to deterioration caused by charging and discharging may be employed as the storage body, but employment of a lithium ion battery leads to an increase in the cost of the storage body. In other words, the storage body installed in the vehicle 11 requires a sufficient storage capacity to be able to drive the starter motor 17 after the vehicle has been left unattended for a predetermined period (three months, for example), but since the cost of a lithium ion battery per storage capacity unit is high, securing the required storage capacity requires a large expenditure on the storage body. To avoid this increase in the cost of the storage body, the vehicle power supply apparatus 10 according to this embodiment of the present invention is constituted as follows.

The constitution of the vehicle power supply apparatus 10 will now be described. The vehicle power supply apparatus 10 is provided with a main battery 20 serving as a first storage body. Further, the starter motor 17 and the alternator 18 are connected to the main battery 20. The main battery 20, starter motor 17, and alternator 18 together constitute a first power supply system 21. Note that an allowable voltage range of the main battery 20 and the alternator 18 constituting the first power supply system 21 is set between approximately 12 V and 18V. In other words, an upper limit voltage for controlling the main battery 20 and the alternator 18 is set at 18 V. Further, a storage body exhibiting low charge/discharge resistance and a superior cycle characteristic is used as the main battery 20. A so-called rocking chair type storage body such as a lithium ion battery, a lithium ion capacitor, an electric double layer capacitor, and a nickel hydrogen battery may be cited as an example of this type of storage body. Note that here, a rocking chair type storage body denotes a storage body that is charged and discharged when lithium ions, hydrogen ions, or the like reciprocate between electrodes. In a storage mechanism of a rocking chair type storage body, variation (dissolution and deposition) in the physical structure of the electrodes does not occur, and therefore a rocking chair type storage body exhibits low charge/discharge resistance and a superior cycle characteristic.

The vehicle power supply apparatus 10 is provided with a sub-battery 22 serving as a second storage body. Electrical equipment 26 such as a headlight 23, an ignition coil 24, and an electronic control unit 25 is connected to the sub-battery 22 as an electric load. The sub-battery 22 and the electrical equipment 26 together constitute a second power supply system 27. Note that an allowable voltage range of the sub-battery 22 and the electrical equipment 26 constituting the second power supply system 27 is set between approximately 12 V and 15 V. In other words, an upper limit voltage for controlling the sub-battery 22 and the electrical equipment 26 is set at 15 V. Further, a storage body having a predetermined storage capacity is used as the sub-battery 22. The storage capacity of the sub-battery 22 is set in consideration of a starting performance after the vehicle has been left unattended for a predetermined period. A so-called reserve type storage body such as a lead storage battery, which is inexpensive and has a large storage capacity, may be cited as an example of this type of storage body. Note that here, a reserve type storage body denotes a storage body that is charged and discharged when ions dissolve into an electrolyte from the metal of an electrode or the like and the ions in the electrolyte are deposited on an electrode as a metal or the like. In a storage mechanism of a reserve type storage body, variation (dissolution and deposition) occurs in the physical structure of the electrodes, and therefore a reserve type storage body exhibits larger charge/discharge resistance and a poorer cycle characteristic compared to a rocking chair type storage body. The sub-battery 22 is not limited to a reserve type storage body, and as long as the predetermined storage capacity can be secured at low cost, a rocking chair type storage body may be used as the sub-battery 22.

Further, a switch 31 such as an n-channel FET is provided on a current carrying line 30 connecting the first power supply system 21 and the second power supply system 27. When the switch 31 is switched to a connected state, the first power supply system 21 and the second power supply system 27 can be electrically connected. When the switch 31 is switched to a disconnected state, on the other hand, the first power supply system 21 and the second power supply system 27 can be electrically disconnected. To execute switch control on the switch 31, the vehicle power supply apparatus 10 is provided with a power supply control unit (switch control means) 32. The power supply control unit 32 is constituted by a CPU for executing a program, a ROM for storing the program and so on, a RAM for storing data temporarily, an input/output port connected to various sensors and actuators, and so on. The sensors connected to the power supply control unit 32 include an accelerator opening sensor 33 for detecting an operating condition of the accelerator pedal, a vehicle speed sensor 34 for detecting a vehicle speed, a voltage sensor 35 for detecting the voltage of the main battery 20, a current sensor 36 for detecting a current of the main battery 20, a temperature sensor 37 for detecting a temperature of the main battery 20, a voltage sensor 38 for detecting the voltage of the sub-battery 22, and a current sensor 39 for detecting a current of the sub-battery 22.

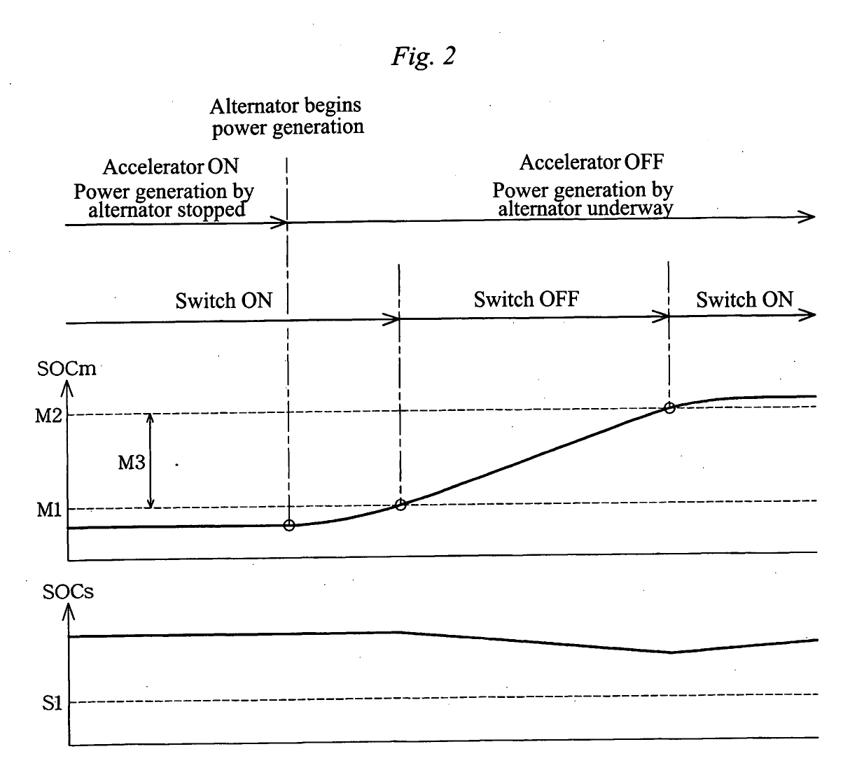

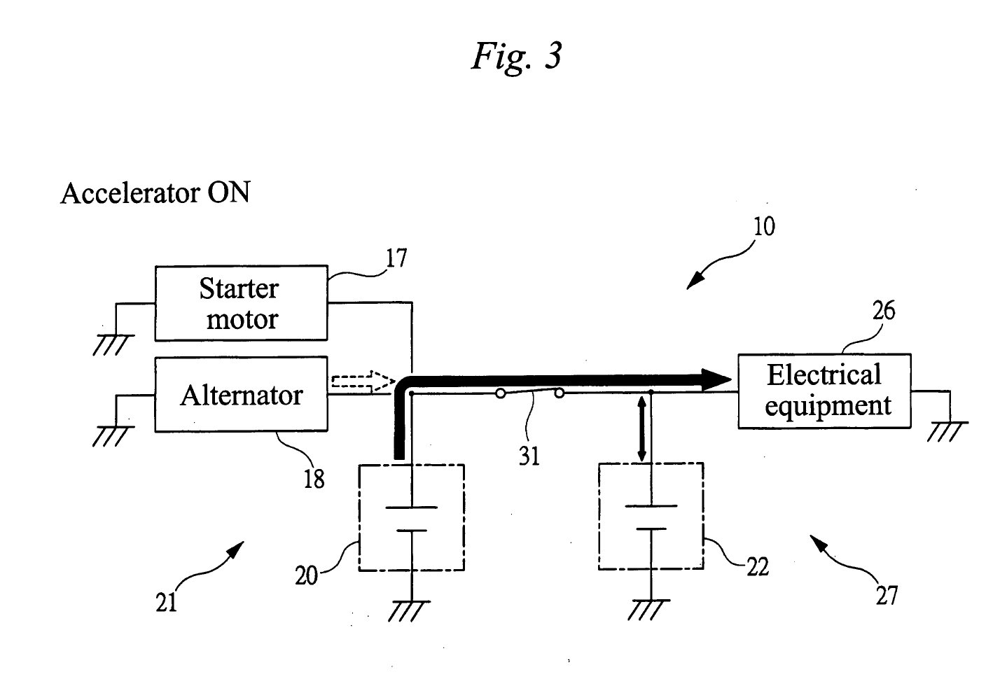

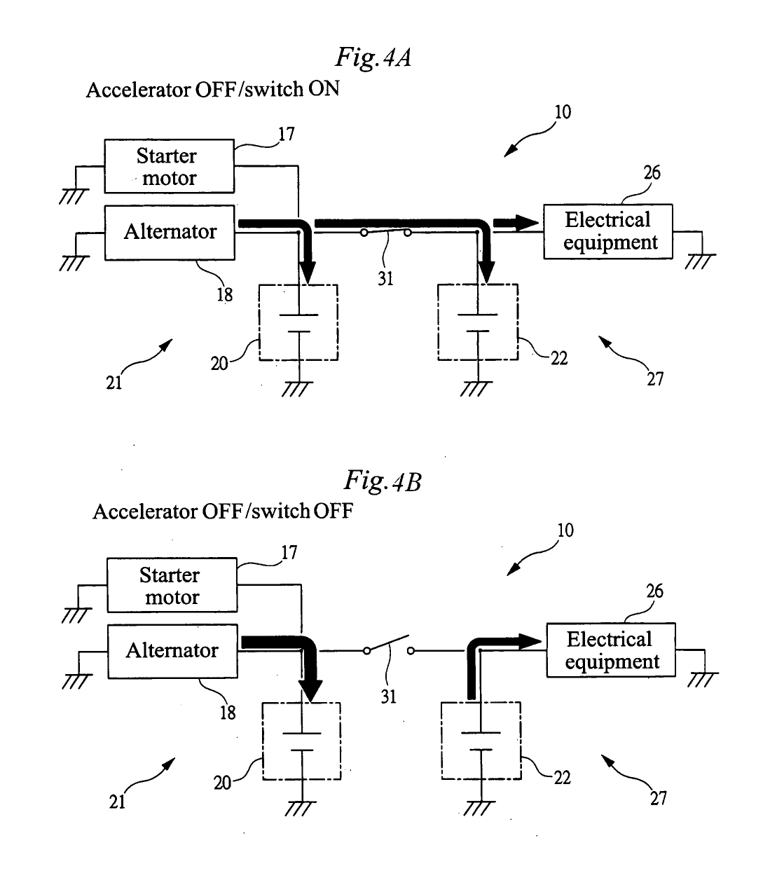

Next, the switch control executed on the switch 31 by the power supply control unit 32 will be described. FIG. 2 is an illustrative view showing control states of the switch 31, and FIG. 3 is an illustrative view showing power supply states of the vehicle power supply apparatus 10. FIG. 3 shows a state in which the accelerator pedal is depressed such that vehicle acceleration or steady travel is underway, or in other words a state in which regeneration control of the alternator 18 is halted. Further, FIGS. 4A and 4B are illustrative views showing power supply states of the vehicle power supply apparatus 10. FIGS. 4A and 4B show a state in which depression of the accelerator pedal is released such that vehicle deceleration is underway, or in other words a state in which regeneration control of the alternator 18 is underway. Note that in FIGS. 3 to 4B, the power supply states are indicated using black arrows.

As shown in FIGS. 2 and 3, when the accelerator pedal is depressed (accelerator ON), the power supply control unit (power generation control means) 32 sets a target generation current of the alternator 18 at “0”, whereby the alternator 18 halts generating power. At this time, the switch 31 is maintained in the connected state (ON) by the power supply control unit 32 such that the main battery 20 and the sub-battery 22 are connected to the electrical equipment 26. Here, a voltage range in which the storage capacity of the main battery 20 can be exerted is designed to be higher than a voltage range in which the storage capacity of the sub-battery 22 can be exerted, and therefore power is supplied mainly from the main battery 20 to the electrical equipment 26 while power supply from the sub-battery 22 is suppressed. Note that when states of charge SOCm, and SOCs indicating a storage ratio of the main battery 20 and the sub-battery 22 decrease, the alternator 18 may be driven to generate power depending on conditions, as shown by a dotted-line arrow in FIG. 3.

When depression of the accelerator pedal is released (accelerator OFF), as shown in FIG. 2, the power supply control unit 32 sets the target generation current of the alternator 18 in accordance with the vehicle speed, whereby the alternator 18 adjusts a generation voltage to obtain the target generation current. During this regeneration control of the alternator 18, it is important to increase a regeneration amount (a power generation amount) achieved by the alternator 18, and therefore the power supply control unit 32 switches the switch 31 from the connected state (ON) to the disconnected state (OFF) in accordance with the states of charge SOCm and SOCs of the main battery 20 and the sub-battery 22. As shown in FIG. 4A, when the switch 31 is maintained in the connected state, the first power supply system 21 and the second power supply system 27 remain electrically connected. Accordingly, to protect the second power supply system 27, the upper limit voltage of which is 15 V, the generation voltage of the alternator 18 must be suppressed to or below 15 V. When the switch 31 is switched from the connected state to the disconnected state, on the other hand, as shown in FIG. 4B, the first power supply system 21 and the second power supply system 27 are electrically disconnected. Accordingly, the alternator 18 and the main battery 20 are disconnected from the second power supply system 27, and therefore the generation voltage of the alternator 18 can be set above the upper limit voltage (15 V) of the second power supply system 27.

Hence, by switching the switch 31 to the disconnected state, the generation voltage of the alternator 18 can be raised, and as a result, the regeneration amount can be increased dramatically. Moreover, since the charge resistance of the main battery 20 constituted by a rocking chair type storage body is small, power can be taken in at a large current (200 A, for example). Hence, generated power, which increases as the generation voltage rises, can be stored in the main battery 20 without waste. Note that even though the switch 31 is disconnected, power is supplied to the electrical equipment 26 from the sub-battery 22, and therefore the electrical equipment 26 can be operated normally.

As described above, by providing the first power supply system 21 constituted by the main battery 20 and the alternator 18 and the second power supply system 27 constituted by the sub-battery 22 and the electrical equipment 26 and providing the switch 31 between the first power supply system 21 and the second power supply system 27, the regeneration amount of the alternator 18 during deceleration can be increased dramatically. Hence, the main battery 20 can be charged sufficiently during deceleration, and therefore the alternator 18 can be halted during acceleration and steady travel. As a result, an engine load can be reduced, enabling an improvement in the fuel efficiency of the vehicle 11. Furthermore, by raising the generation voltage without relying solely on the charge resistance of the main battery 20, as described above, the regeneration amount of the alternator 18 can be increased during deceleration. Accordingly, there is less need to increase the number of parallel main batteries 20 constituted by lithium ion batteries or the like in order to reduce the charge resistance, and therefore the designed storage capacity can be reduced, enabling reductions in the size and cost of the vehicle power supply apparatus 10. Note that the storage capacity of the main battery 20 is designed to be smaller than the storage capacity of the sub-battery 22. Moreover, by halting the alternator 18 during acceleration, the engine load can be suppressed, enabling an improvement in an acceleration performance of the vehicle 11.

Further, by providing the sub-battery 22 having a secured predetermined storage capacity, a favorable starting performance can be obtained after the vehicle has been left unattended for a predetermined period. By employing a reserve type storage body such as a lead storage battery, which is inexpensive and has a large storage capacity, as the sub-battery 22, an increase in the cost of the vehicle power supply apparatus 10 can be suppressed. Furthermore, as described above, when regeneration control of the alternator 18 is halted, the switch 31 is connected such that power is supplied to the electrical equipment 26 from the main battery 20, and as a result, charging and discharging of the sub-battery 22 can be suppressed. Hence, even when a reserve type storage battery that deteriorates due to frequent charging and discharging is used as the sub-battery 22, deterioration of the sub-battery 22 can be suppressed. Note that the main battery 20 constituted by a rocking chair type storage body exhibits a favorable cycle characteristic and does not therefore deteriorate rapidly even when charged and discharged frequently.

Furthermore, the storage capacity of the sub-battery 22, which is provided for use as a backup when the switch is disconnected, can be reduced in comparison with a conventional battery, and therefore, even when the main battery 20 and the sub-battery 22 are combined, the size thereof can be kept equal to the size of a conventional battery. Accordingly, the vehicle power supply apparatus 10 can be installed in an engine room in a similar manner to a conventional vehicle having only a lead storage battery. As a result, the vehicle power supply apparatus 10 according to the present invention can be installed without greatly modifying a vehicle body structure.

Moreover, in the vehicle power supply apparatus 10, the main battery 20 having a high voltage range (approximately 12 V to 18 V) in which the storage capacity can be exerted and the sub-battery 22 having a low voltage range (approximately 11 V to 12.8 V) in which the storage capacity can be exerted are connected in parallel. Therefore, even when a lead storage battery is used as the sub-battery 22, a usable storage capacity (an effective storage capacity) can be increased greatly without discharging the lead storage battery in comparison with a conventional vehicle having only a lead storage battery. Further, by connecting the main battery 20 and the sub-battery 22 in parallel, an overall electric resistance of the batteries can be reduced, and as a result, the voltage applied to the electrical equipment 26 can be stabilized.

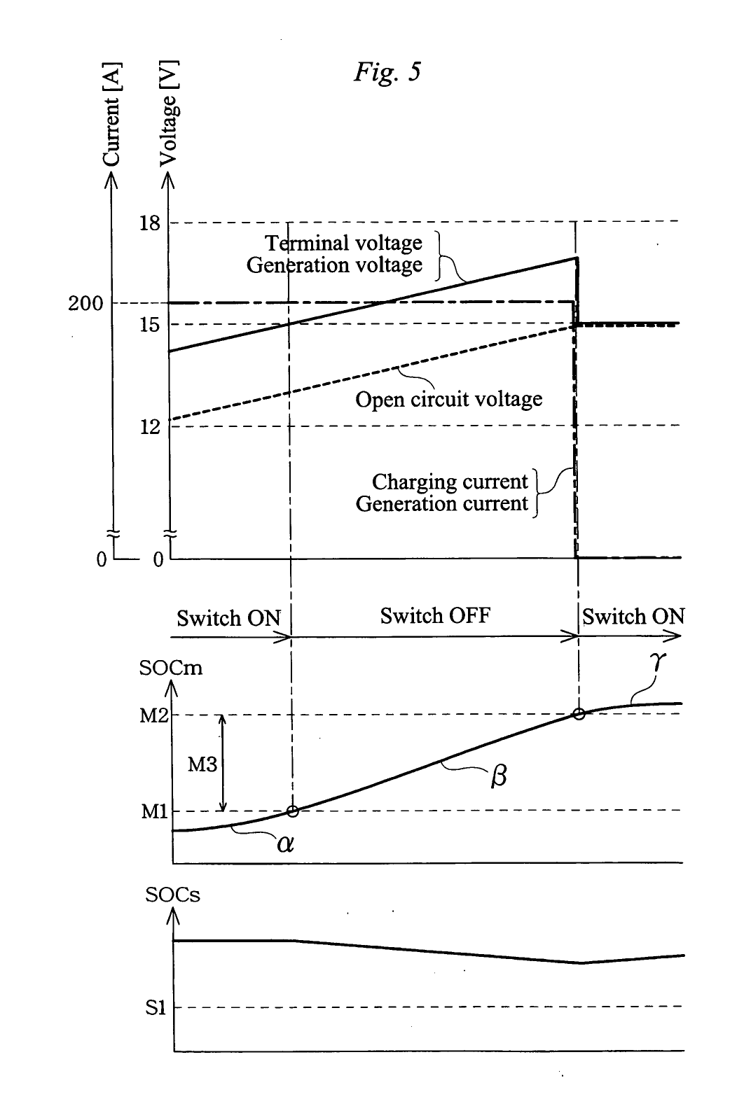

The switch control executed on the switch 31 and the regeneration control of the alternator 18 will now be described in detail. FIG. 5 is an illustrative view showing a relationship between the switch control executed on the switch 31 and the regeneration control of the alternator 18. Note that a terminal voltage, an open circuit voltage, and a charging current shown in FIG. 5 denote a terminal voltage and an open circuit voltage of the main battery 20 and a charging current applied to the main battery 20. Further, FIG. 5 shows a state in which depression of the accelerator pedal is released such that deceleration is underway, or in other words a state in which the regeneration control is executed by the alternator 18. First, the power supply control unit 32 calculates the state of charge SOCm of the main battery 20 on the basis of the voltage, current and temperature of the main battery 20. Further, the power supply control unit 32 calculates the state of the charge SOCs of the sub-battery 22 on the basis of the voltage and current of the sub-battery 22.

As shown in FIG. 5, when the state of charge SOCm of the main battery 20 falls below a predetermined value M1 (reference symbol α), the power supply control unit 32 holds the switch 31 in the connected state. When the state of charge SOCm decreases, the open circuit voltage of the main battery 20 is low, and therefore a predetermined target generation current (200 A, for example) can be obtained without raising the generation voltage to 15 V. In other words, the predetermined value M1 is set in advance on the basis of experiments and simulations such that the predetermined target generation current can be obtained within a lower generation voltage range than 15 V. When the required generation current is obtained without disconnecting the switch 31 in this manner, charging and discharging of the sub-battery 22 are suppressed, and therefore the alternator 18 is driven to generate power while the switch 31 remains connected. Note that when a lead storage battery is used as the sub-battery 22, the generation voltage is preferably controlled to or above 12.8 V in order to prevent deterioration caused by over-discharge.

When the state of charge SOCm of the main battery 20 exceeds the predetermined value M1 in a state where the state of charge SOCs of the sub-battery 22 exceeds a predetermined value S1 (reference symbol β), the power supply control unit 32 switches the switch 31 to the disconnected state. Hence, in a state where the terminal voltage of the main battery 20 exceeds 15 V due to an increase in the state of charge SOCm, the switch 31 is switched to the disconnected state. Thus, the generation voltage can be raised to or above 15 V, and as a result, the predetermined target generation current (200 A, for example) can be secured. Further, power is supplied to the electrical equipment 26 from the sub-battery 22 while the switch 31 is disconnected, and therefore the switch 31 is disconnected after checking the state of charge SOCs of the sub-battery 22. More specifically, when the state of charge SOCs is lower than the predetermined value S1, the power supply control unit 32 prohibits disconnection of the switch 31. Note that the predetermined value S1 is set in advance on the basis of experiments and simulations such that sufficient power can be supplied to the electrical equipment 26 from the sub-battery 22.

Further, when the main battery 20 is charged to a point where the state of charge SOCm exceeds a predetermined value M2 (symbol γ), the power supply control unit 32 switches the switch 31 back to the connected state. When the state of charge SOCm exceeds the predetermined value M2, the open circuit voltage of the main battery 20 reaches the upper limit voltage 15 V of the electrical equipment 26, and therefore, if power generation is continued at 15 V or more, the open circuit voltage of the main battery 20 rises above 15 V, i.e. the upper limit voltage of the electrical equipment 26. In other words, if the generation voltage continues to be raised, the open circuit voltage of the main battery 20 exceeds 15 V, and therefore, to prevent damage caused when an excessive voltage is applied to the electrical equipment 26, the switch 31 is connected to return the generation voltage of the alternator 18 to 15 V. Note that the predetermined value M2 is a state of charge SOC of the main battery 20 corresponding to the upper limit voltage of the electrical equipment 26, which is set in advance on the basis of the specifications of the electrical equipment 26. Hence, when the state of charge SOCm of the main battery 20 falls below the predetermined value M1 or exceeds the predetermined value M2, the switch 31 is controlled to the connected state. In other words, when the state of charge SOCm deviates from a predetermined range M3 defined by the predetermined values M1 and M2, the power supply control unit 32 prohibits disconnection of the switch 31.

As described above, when the switch 31 is disconnected, the generation voltage is raised to 18 V, i.e. the upper limit voltage of the first power supply system 21, and as a result, the terminal voltage of the main battery 20 also increases to 18V. However, the open circuit voltage of the main battery 20 is designed to remain below 15 V, i.e. the upper limit voltage of the second power supply system 27, even in this case. Hence, the open circuit voltage of the main battery 20 is controlled below 15 V likewise when the generation voltage is raised accompanying disconnection of the switch 31. The switch 31 can therefore be safely switched from the disconnected state to the connected state. Note that the upper limit voltage of the first power supply system 21, i.e. 18 V, is set on the basis of a test voltage (18 V) used in a withstand voltage test performed on the electrical equipment 26. Hence, even in the case in which the switch 31 is connected erroneously when the generation voltage is raised to 18 V, damage to the electrical equipment 26 can be avoided.

Further, upon switching the switch 31 to the disconnected state, while the states of charge SOCm and SOCs are determined, a determination is also made in relation to a disconnection history of the switch 31 during the current regeneration window. More specifically, disconnection of the switch 31 is permitted only once during a single regeneration window after depression of the accelerator pedal has been released. As a result, hunting in which the switch 31 is switched repeatedly between the disconnected state and the connected state can be prevented.

Note that the state of charge SOCm of the main battery 20 is calculated by a method in which a state of charge SOCc is calculated based on an integrated value of a charge and a discharge current and a state of charge SOCv is calculated based on an estimated open circuit voltage, and then the state of charge SOCm is calculated by weighted synthesis of the states of charge SOCc and SOCv (see Japanese Unexamined Patent Application Publication No. 2005-201743, for example). Further, the state of charge SOCs of the sub-battery 22 is calculated by integrating the charge current and a discharge current. It goes without saying that the methods of calculating the states of charge SOCm and SOCs are not limited to those described above, and another calculation method may be used.

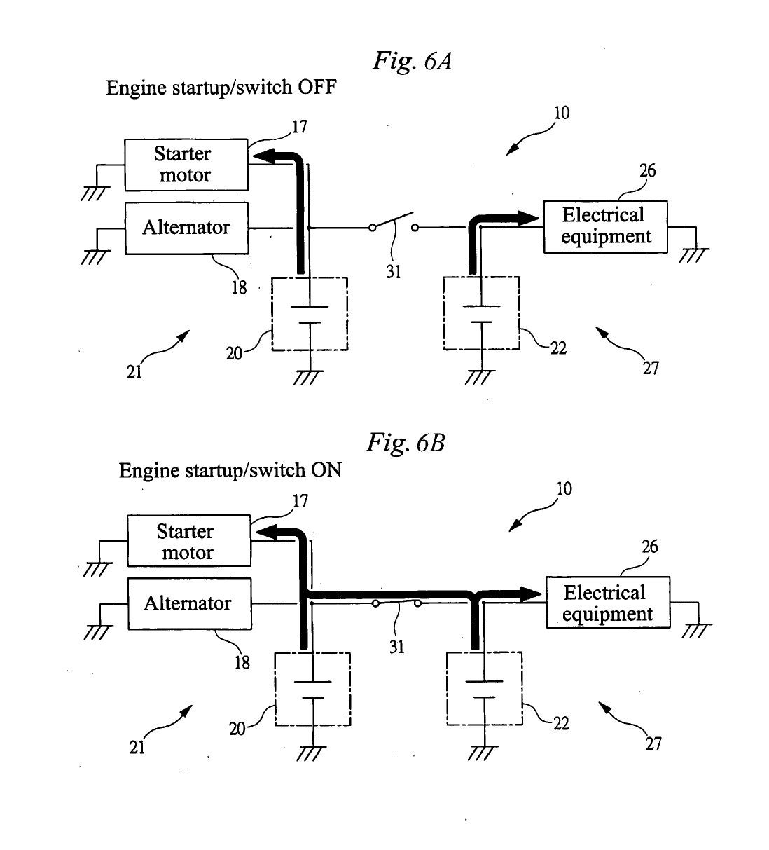

Next, power supply states of the vehicle power supply apparatus 10 during engine startup will be described. FIGS. 6A and 6B are illustrative views showing power supply states of the vehicle power supply apparatus 10 during engine startup. Note that in FIGS. 6A and 6B, the power supply states are indicated using black arrows. For example, when an outside air temperature is higher than 0° C., the switch 31 is switched to the disconnected state during engine startup. As shown in FIG. 6A, when the switch 31 is switched to the disconnected state, power is supplied to the starter motor 17 from the main battery 20 and power is supplied to the electrical equipment 26 from the sub-battery 22. Hence, in an environment where the engine 12 can be started easily, the starter motor 17 is driven using only power from the main battery 20. In so doing, a reduction in the voltage of the sub-battery 22 caused by a large starter current can be avoided. As a result, a momentary power failure can be prevented from occurring in electrical equipment (a navigation apparatus and light fittings such as a headlight, for example) having a high lower limit voltage compared to electrical equipment (travel-related control units such as an ECU (Engine Control Unit) and a TCU (Transmission Control Unit), for example) having a low lower limit voltage. When the outside air temperature is equal to or lower than 0° C., for example, the switch 31 is switched to the connected state during engine startup. As shown in FIG. 6B, when the switch 31 is switched to the connected state, power is supplied to the starter motor 17 and the electrical equipment 26 from both the main battery 20 and the sub-battery 22. Hence, in an environment where the engine 12 cannot be started easily, the starter motor 17 is driven using power from both the main battery 20 and the sub-battery 22. Note that power is supplied to the electrical equipment 26 from the sub-battery 22 regardless of the control state of the switch 31, as shown in FIGS. 6A and 6B. In so doing, a momentary voltage reduction occurring when a large current is supplied to the starter motor 17 can be avoided, and as a result, failure of the control system during engine startup can be avoided.

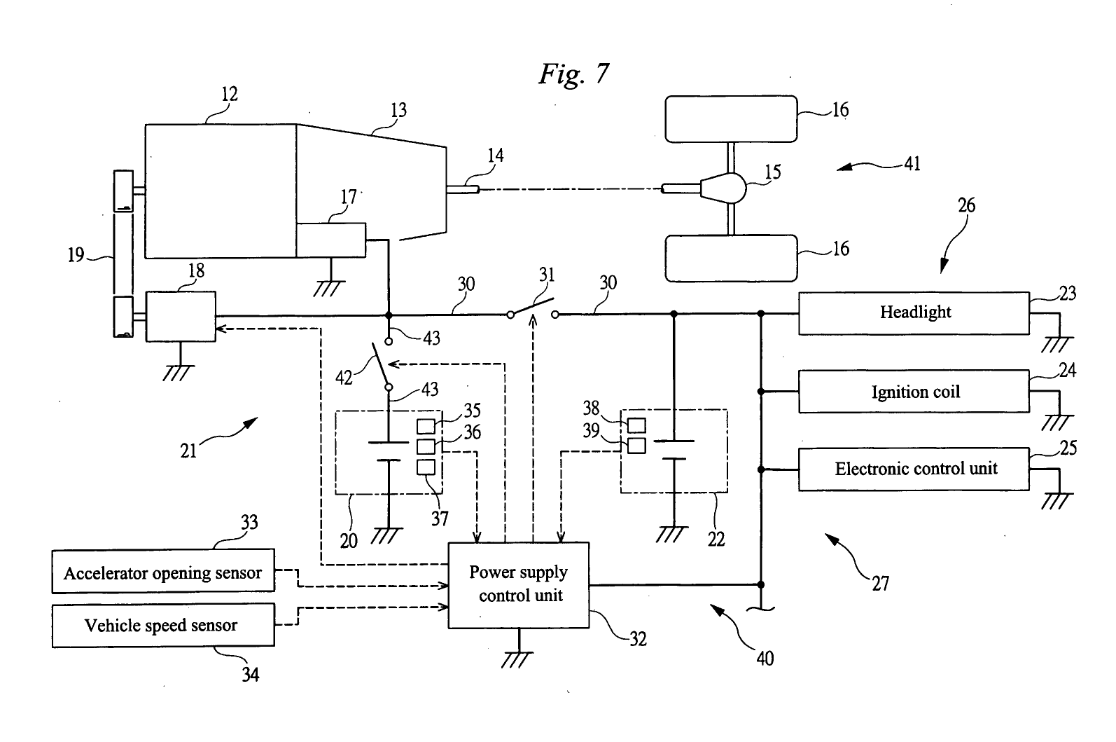

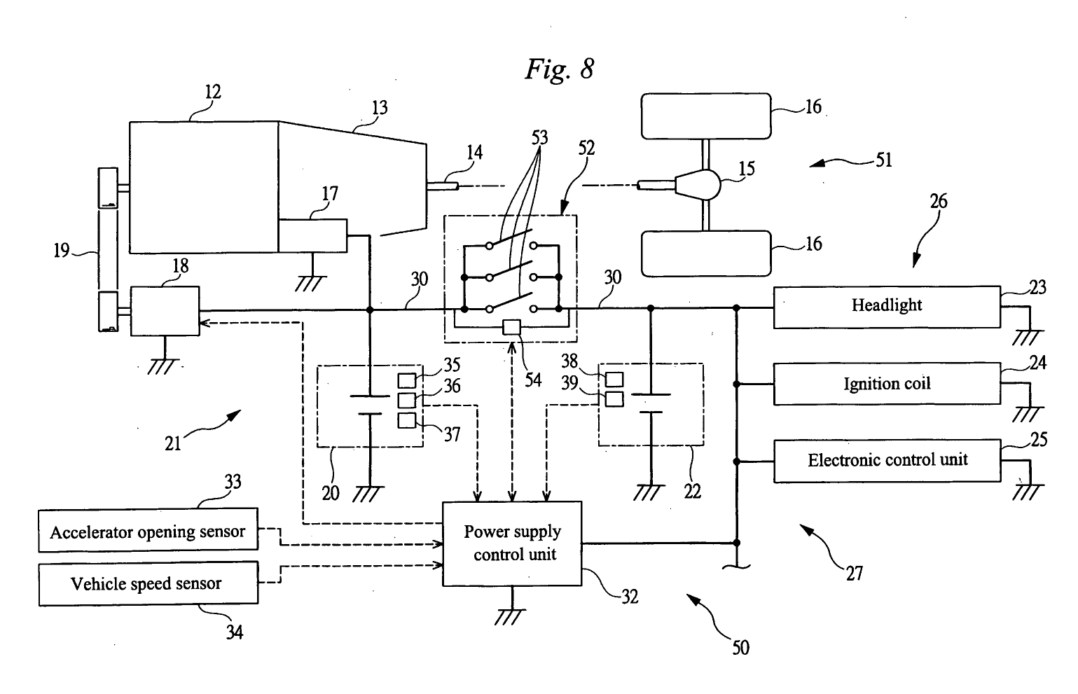

Next, vehicle power supply apparatuses 40 and 50 according to other embodiments of the present invention will be described. FIGS. 7 and 8 are schematic views showing the constitutions of vehicles 41 and 51 including the vehicle power supply apparatuses 40 and 50 according to further embodiments of the present invention. Note that in FIGS. 7 and 8, identical reference numerals have been allocated to similar constitutional elements to those shown in FIG. 1 and descriptions thereof have been omitted. As shown in FIG. 7, in the vehicle power supply apparatus 40, a switch 42 is provided in a position for disconnecting the main battery 20 from the first power supply system 21. By providing the switch 42 on a positive electrode line 43 of the main battery 20 in this manner, the main battery 20 can be disconnected from the vehicle power supply apparatus 40 when an abnormality occurs in the main battery 20. Thus, the vehicle 41 can be activated using the sub-battery 22 without operating the abnormal main battery 20. As a result, the safety of the vehicle 41 can be improved.

As shown in FIG. 8, in the vehicle power supply apparatus 50, a switch unit 52 is provided on the current carrying line 30 connecting the first power supply system 21 and the second power supply system 27. The switch unit 52 is constituted by a plurality of switches 53 connected in parallel. Further, the plurality of switches 53 constituting the switch unit 52 are switched between the connected state and the disconnected state at an identical timing. The switch unit 52 is also provided with a voltage sensor 54 for detecting a potential difference between the front and rear of the switch. The power supply control unit 32 determines the presence of a defect in the switch unit 52 by comparing a voltage signal from the voltage sensor 54 to a predetermined determination value. More specifically, the power supply control unit 32 defines the determination value as a voltage reduction occurring when all of the switches 53 are connected normally, and determines whether or not an actual voltage reduction deviates from the determination value. When the actual voltage reduction is larger than the determination value, the power supply control unit 32 determines that an internal resistance of the switch unit 52 is large, or in other words that an abnormality whereby not all of the switches 53 are connected normally has occurred. An abnormality in the switch unit 52 causes a large voltage reduction to appear in the switch unit 52, and therefore the abnormality determination is preferably performed when a current is supplied to the starter motor 17 from the sub-battery 22. By determining the presence of an abnormality in the switch unit 52 during engine startup in this manner, the presence of an abnormality in the switch unit 52 can be detected prior to vehicle travel, and therefore measures such as displaying a warning light can be taken prior to vehicle travel, enabling an improvement in the safety of the vehicle 51.

The present invention is not limited to the embodiments described above and may be subjected to various modifications within a scope that does not depart from the spirit thereof. For example, in the drawings, the present invention is applied to the vehicles 11, 41 and 51 having only the engine 12 as a power source, but the present invention is not limited thereto and may be applied to a hybrid vehicle having the engine 12 and an electric motor as power sources. The present invention can be applied particularly effectively to a vehicle exhibiting high power consumption. For example, in a so-called idling-stop vehicle, in which the engine 12 is stopped automatically under predetermined conditions, the starter motor 17 must be driven frequently, and therefore the present invention can be applied extremely effectively.

Further, in the above description, when the alternator 18 is driven to generate power, the target generation current is set in accordance with the vehicle speed, but the present invention is not limited thereto, and the target generation current may be set on the basis of other information. Moreover, in the drawings, the alternator 18 and the starter motor 17 are provided separately, but an electric motor having the functions of both the alternator 18 and the starter motor 17 may be provided instead. Note that the allowable voltage range of the first power supply system 21 is set between approximately 12 and 18 V in the above description, but is not limited to this voltage range. Similarly, the allowable voltage range of the second power supply system 27 is set between approximately 12 and 15 V but is not limited to this voltage range.

What is claimed is:

1. A vehicle power supply apparatus comprising:
a first power supply system including a power generator and a first storage body connected to the power generator;
a second power supply system including an electric load having a lower upper limit voltage than the power generator and a second storage body connected to the electric load; and
a switch that is provided between the first power supply system and the second power supply system, and is switched between a connected state in which the first power supply system and the second power supply system are connected and a disconnected state in which the first power supply system and the second power supply system are disconnected.

2. The vehicle power supply apparatus according to claim 1, wherein, when the switch is switched to the disconnected state, a generation voltage of the power generator is set to be higher than the upper limit voltage of the electric load, and when the switch is switched to the connected state, the generation voltage of the power generator is set at or below the upper limit voltage of the electric load.

3. The vehicle power supply apparatus according to claim 1, wherein the switch is switched to the disconnected state during vehicle deceleration.

4. The vehicle power supply apparatus according to claim 2, wherein the switch is switched to the disconnected state during vehicle deceleration.
